(19) United States
(12) Patent Application Publication
(10) Pub. No.: US 2015/0029847 A1
(43) Pub. Date: Jan. 29, 2015

(54) PACKET NETWORK TRAFFIC FLOW EFFECTIVE BANDWIDTH ESTIMATION APPARATUS AND METHOD

(71) Applicant: Marzio Puleri, Fiano Romano (RM) (IT)

(72) Inventor: Marzio Puleri, Fiano Romano (RM) (IT)

(73) Assignee: TELEFONAKTIEBOLAGET L M ERICSSON (PUBL), Stockholm (SE)

(21) Appl. No.: 14/378,964

(22) PCT Filed: Feb. 23, 2012
(86) PCT No.: PCT/EP2012/053059

§ 371 Date: Aug. 14, 2014

(30) Foreign Application Priority Data
Feb. 16, 2012 (EP) 12155787.0

(51) Int. Cl. H04L 12/825

(52) U.S. Cl. CPC H04L 47/25
USPC 370/233

(57) ABSTRACT

A packet network traffic flow effective bandwidth estimation apparatus comprising a committed burst size (CBS) estimator loop, a peak information rate (PIR) estimator and an effective bandwidth (Eff.BW) estimator. The loop includes a meter arranged to determine a number of conformant bytes (G) and a number of violating bytes (Y) of a traffic flow; a committed information rate (CIR) estimator arranged to determine a subsequent estimated CIR; a controller arranged to, if Y is above zero, determine an estimated CBS (ECBS) correction and to apply the correction to the ECBS, and arranged to, if Y is zero, output the previously used ECBS. The PR estimator receives the ECBS from the loop and the ECIR and determines an estimated PR (EPIR) in dependence on the ECBS and the ECIR. The Eff.BW estimator determines an Eff.BW of the traffic flow from the EPIR, ECBS and ECIR.

### TECHNICAL FIELD

The invention relates to packet network traffic flow effective bandwidth estimation apparatus and to a communications network switching node comprising the packet network traffic flow effective bandwidth estimation apparatus. The invention further relates to a method of estimating an effective bandwidth of a traffic flow in a packet network.

### BACKGROUND

Self-sizing of multi-class packet networks is required to achieve efficient exploitation of network resources providing the proper level of Quality of Service (QoS) to each traffic class, as reported by H. Che and S. Li, “Fast algorithms for measurement-based traffic modeling”, InfoCom '97, April 1997, pages 177-186. Typically this is achieved by estimating the Effective Bandwidth needed by each connection to satisfy its characteristics. This can be done manually and statically or using measurements. However, since traffic is often not know a priori, the measurement approach is the most suitable to optimize usage of network resources, as it follows traffic changes in real-time and adapts to them, allocating to each connection just the required bandwidth. A self-sizing network architecture enables maximal network resource utilization, ensuring that QoS parameters are met. The Internet Engineering Task Force has proposed a general Real-time Traffic Flow Measurement (RTFM) architecture, RFC 2722, where the traffic analysis function makes the difference in terms of performance.

All the proposed systems and methods suffer from a slow mechanism for determining the effective bandwidth to be allocated. Typically several minutes are needed to estimate the autocorrelation function and other parameters. As reported by H. Che and S. Li, (ibid), looking at packet traffic characteristics it is evident that IP traffic has both short and long term dynamics. The long term characteristic is the one that mostly affects network resource allocation. Looking at the power spectrum of traffic, it is clear that the frequency range of long term variations is typically in the range ωε[0,10], which means that a traffic flow keeps a stable long term behaviour for at least 0.6 s. This means that current traffic modelers are not able to follow traffic characteristics in real-time, but they can be used to estimate traffic average models to be used to provide a sub-optimum solution to the problem. When a fast change in traffic characteristics occurs, current analysis methods typically fail, causing a high level of packet losses. Furthermore current traffic modelers are able to estimate traffic only of specific kinds.

### SUMMARY

It is an object to provide an improved packet network traffic flow effective bandwidth estimation apparatus. It is a further object to provide an improved communications network switching node comprising the packet network traffic flow effective bandwidth estimation apparatus. It is a further object to provide an improved method of estimating an effective bandwidth of a traffic flow in a packet network.

A first embodiment of the invention provides packet network traffic flow effective bandwidth estimation apparatus comprising a committed burst size estimator loop, a peak information rate estimator and an effective bandwidth estimator. The committed burst size estimator loop comprises a meter, a committed information rate estimator, and a controller. The meter is arranged to receive a plurality of traffic packets of a traffic flow comprising a plurality of bytes. The meter is arranged to determine a number of conformant bytes, being bytes of those packets which conform to an estimated committed information rate, ECIR, and an estimated committed burst size, ECBS. The meter is arranged to determine a number of violating bytes, being bytes of those packets which violate at least one of the estimated committed information rate and the estimated committed burst size. The committed information rate estimator is arranged to determine a subsequent estimated committed information rate, being a number of bytes per second, from the number of conformant bytes and the number of violating bytes. The controller is arranged to determine an estimated committed burst size correction in dependence on the number of violating bytes. The controller is arranged to apply the correction to the estimated committed burst size. The controller is arranged to output the previously used estimated committed burst size. The peak information rate estimator is arranged to receive the estimated committed burst size output from the loop and the estimated committed information rate from the committed information rate estimator and is arranged to determine an estimated peak information rate, EPIR, in dependence on the estimated committed burst size. The effective bandwidth estimator is arranged to determine an effective bandwidth, Eff.BW, of the traffic flow from the estimated peak information rate, estimated committed burst size and estimated committed information rate.

The effective bandwidth estimation apparatus may enable traffic flow characteristics to be determined in real-time, on a time-scale of fractions of a second. This is several hundred times faster than is achievable with the prior art and is consistent with the long term behaviour of self-similar traffic flows, which affect buffers in switches. The apparatus may therefore be used to minimize time periods when congestion and losses occur in networks. The apparatus may be used to self-size a multi-class packet network, and may enable an appropriate effective bandwidth to be instantaneously allocated to each traffic flow, thereby maximizing bandwidth exploitation.

The effective bandwidth estimation apparatus may be used in optical burst switching and optical packet switching in optical networks. This may enable real-time bandwidth allocation to be achieved in optical networks, which may overcome the problems of waste of bandwidth currently experienced using “one way” reservation strategies and high jitter currently experienced using “two way” reservation strategies.

In an embodiment, the committed burst size estimator loop is arranged to operate continuingly.

In an embodiment, the meter is arranged to receive traffic packets within an integration period T formed of a plurality, N, of sub-periods, Tᵢ. The meter is arranged to determine the number of conformant bytes, Gᵢ, and the number of violating bytes, Yᵢ, received within each sub-period. The committed information rate estimator is arranged to determine the estimated committed information rate, ECIR, using one of

$$ECIR = \hat{B} \text{/} {T}_{i} and ECIR = \frac{1}{T} {Σ}_{i} {B}_{i} , where {B}_{i} = {Y}_{i} + {G}_{i} .$$

Dividing the integration period into N sub-periods may reduce noise effects in the number of violating bytes.

In an embodiment, the meter is a leaky bucket. In an embodiment, the meter is a traffic regulator. In an embodiment, the meter is a traffic meter of an RFC2698 two rate three colour marker. The meter may therefore be constructed using a standard compliant device.

In an embodiment, the controller is a nonlinear controller. Using a nonlinear controller reduces the amount of oscillation in the correction as compared to using a linear controller, which may enable very fast convergence. In an embodiment, the nonlinear controller is a fuzzy controller comprising a centre of gravity fuzzy system. Using a fuzzy controller may reduce dependence on the characteristics of the traffic flow.

In an embodiment, the fuzzy controller comprises a prescaling block, a rule block, a post-scaling block and a perturbation block. The pre-scaling block is arranged to receive the number of violating bytes and to normalise said number to lie within the range 0 to 1. The rule block is arranged to receive the normalised number and arranged to apply each of a plurality of fuzzy rules to the normalised number to determine a respective output value for each rule and to use the rule that gives the highest output value. The post-scaling block is arranged to convert the output value to an output number of bytes. The perturbation block is arranged to apply a perturbation value to the output number of bytes to form the estimated committed burst size correction. The perturbation value is in an opposite direction to the output number of bytes.

In an embodiment, the controller is arranged to output the previously used estimated committed burst size with the perturbation value applied to it.

In an embodiment, the estimator loop further comprises a violating byte mean estimator arranged to determine a mean value, Ŷ, of the number of violating bytes received within an integration period, as

$$\hat{Y} = \frac{1}{N} {Σ}_{i} {Y}_{i} .$$

Dividing the integration period into N sub-periods may reduce noise effects in Ŷ.

In an embodiment, the controller is arranged to, if the mean value, Ŷ, of the number of violating bytes is above zero, determine an estimated committed burst size correction in dependence on the mean value. The controller is arranged to apply the correction to the estimated committed burst size. The controller is arranged to, if the mean value is zero, output the previously used estimated committed burst size with the perturbation value applied to it.

In an embodiment, the fuzzy controller pre-scaling block is arranged to receive the mean value of the number of violating bytes and to normalise the mean value to lie within the range 0 to 1. The rule block is arranged to receive the normalised mean value and arranged to apply each of a plurality of fuzzy rules to the normalised mean value to determine a respective output value for each rule and to use the rule that gives the highest output value. The post-scaling block is arranged to convert the output value to an output number of bytes. The perturbation block arranged to apply a perturbation value to the output number of bytes to form the estimated committed burst size correction. The perturbation value is in an opposite direction to the previously applied correction.

The meter operates such that there are no violating bytes if the ECBS is greater than or equal to the committed burst size, CBS. Therefore if the last correction value that is applied is too big, it would be possible for the estimation to fail, since ECBS could be greater then the real CBS without it being possible to detect this. The perturbation block introduces a variation on the controller output in the opposite direction of the last correction, decreasing the output of the controller by a quantity proportional to the output of the post-scaling block. In this way, if ECBS≧CBS the last non-zero computed perturbation value is applied time by time to the output allowing convergence to the real CBS. The presence of the perturbation block introduces a small controllable and negligible oscillation on the ECBS, when in steady state.

In an embodiment, each fuzzy rule has the form out_{Rj}=μ_{Rj}(x)·Cⱼ where μ_{Rj} is a membership function of the x value to the fuzzy set related to rule Rⱼ and Cⱼ is a centroid of an output crisp set of the rule.

In an embodiment, the fuzzy rules membership functions and centroids are:

| | |
|---|---|
| Rule 0: (0, 0.005, 0.005, 0.015) | C0: 0.0025 |
| Rule 1: (0.005, 0.015, 0.02, 0.1) | C1: 0.0075 |
| Rule 2: (0.02, 0.05, 0.1, 0.25) | C2: 0.025 |
| Rule 3: (0.1, 0.25, 0.35, 0.5) | C3: 0.25 |
| Rule 4: (0.35, 0.5, 0.75, 1.0) | C4: 0.5 |
| Rule 5: (0.75, 1.0, 1.0, 1.0) | C5: 1.0 |

In an embodiment, the peak information rate estimator is arranged to solve the operating research problem:

$$find max x \text{:}$$

$$x = \frac{1}{1 - \frac{ECBS}{\hat{B}} \cdot n}$$

$$n < {N}_{MAX}$$

and to determine the estimated peak information rate as EPIR=x·ECIR

Determining EPIR in this way may overcome the problem of defining an appropriate integration window for determining

$$\hat{PIR} = \frac{arrived bytes}{time window}$$

for different traffic flows. It may also avoid over-sampling and noise effects or sub-sampling. The PIR estimator ensures that as soon as ECIR and ECBS are meaningful, the PIR estimation becomes significant.

In an embodiment, the x exploration is implemented for x in the range 2 to 10. In an embodiment, the operating research problem is solved using a linear programming method.

In an embodiment, the effective bandwidth estimator is arranged to apply the equation:

$$Eff . BW = \frac{EPIR}{1 + \frac{D}{ECBS} \cdot ( EPIR - ECIR )}$$

This may provide a simple, practical way of determining the effective bandwidth.

In an embodiment, the packet network traffic flow effective bandwidth estimation apparatus comprises a main logic controller arranged to generate and transmit a sampling command signal and an estimate command signal. The sampling command signal is arranged to cause the committed information rate estimator to obtain the number of conformant bytes, Gᵢ, and the number of violating bytes, Yᵢ, received by the meter within each sub-period and is arranged to cause the violating byte mean estimator to obtain the number of violating bytes, Yᵢ. The estimate command signal is arranged to cause the violating byte mean estimator to determine the mean value, Ŷ, and is arranged to cause the committed information rate estimator to determine the estimated committed information rate, ECIR, using one of

$$ECIR = \hat{B} \text{/} {T}_{i} and ECIR = \frac{1}{T} {Σ}_{i} {B}_{i} , where {B}_{i} = {Y}_{i} + {G}_{i} .$$

In an embodiment, the packet network is a communications network. In an embodiment, the packet network is one of an optical packet switching network and an optical burst switching network.

A second aspect of the invention provides a communications network switching node comprising packet network traffic flow effective bandwidth estimation apparatus. The packet network traffic flow effective bandwidth estimation apparatus comprises a committed burst size estimator loop, a peak information rate estimator and an effective bandwidth estimator. The committed burst size estimator loop comprises a meter, a committed information rate estimator, and a controller. The meter is arranged to receive a plurality of traffic packets of a traffic flow comprising a plurality of bytes. The meter is arranged to determine a number of conformant bytes, being bytes of those packets which conform to an estimated committed information rate, ECIR, and an estimated committed burst size, ECBS. The meter is arranged to determine a number of violating bytes, being bytes of those packets which violate at least one of the estimated committed information rate and the estimated committed burst size. The committed information rate estimator is arranged to determine a subsequent estimated committed information rate, being a number of bytes per second, from the number of conformant bytes and the number of violating bytes. The controller is arranged to determine an estimated committed burst size correction in dependence on the number of violating bytes. The controller is arranged to apply the correction to the estimated committed burst size. The controller is arranged to output the previously used estimated committed burst size. The peak information rate estimator is arranged to receive the estimated committed burst size output from the loop and the estimated committed information rate from the committed information rate estimator and is arranged to determine an estimated peak information rate, EPIR, in dependence on the estimated committed burst size and the estimated committed information rate. The effective bandwidth estimator is arranged to determine an effective bandwidth, Eff.BW, of the traffic flow from the estimated peak information rate, estimated committed burst size and estimated committed information rate.

The effective bandwidth estimation apparatus may enable traffic flow characteristics to be determined in real-time, on a time-scale of fractions of a second. This is several hundred times faster than is achievable with the prior art and is consistent with the long term behaviour of self-similar traffic flows, which affect buffers in switches. The node may therefore be used to minimize time periods when congestion and losses occur in networks. The apparatus may be used to self-size a multi-class packet network, and may enable the node to instantaneously allocate an appropriate effective bandwidth to each traffic flow, thereby maximizing bandwidth exploitation.

The node may be used in optical burst switching and optical packet switching in optical networks. This may enable real-time bandwidth allocation to be achieved in optical networks, which may overcome the problems of waste of bandwidth currently experienced using “one way” reservation strategies and high jitter currently experienced using “two way” reservation strategies.

In an embodiment, the committed burst size estimator loop is arranged to operate continuingly. In an embodiment, the meter is arranged to receive traffic packets within an integration period T formed of a plurality, N, of sub-periods, Tᵢ. The meter is arranged to determine the number of conformant bytes, Gᵢ, and the number of violating bytes, Yᵢ, received within each sub-period. The committed information rate estimator is arranged to determine the estimated committed information rate, ECIR, using one of

$$ECIR = \hat{B} \text{/} {T}_{i} and ECIR = \frac{1}{T} {Σ}_{i} {B}_{i} , where {B}_{i} = {Y}_{i} + {G}_{i} .$$

Dividing the integration period into N sub-periods may reduce noise effects in the number of violating bytes.

In an embodiment, the meter is a leaky bucket. In an embodiment, the meter is a traffic regulator. In an embodiment, the meter is a traffic meter of an RFC2698 two rate three colour marker. The meter may therefore be constructed using a standard compliant device.

In an embodiment, the controller is a nonlinear controller. Using a nonlinear controller reduces the amount of oscillation in the correction as compared to using a linear controller, which may enable very fast convergence. In an embodiment, the nonlinear controller is a fuzzy controller comprising a centre of gravity fuzzy system. Using a fuzzy controller may reduce dependence on the characteristics of the traffic flow.

In an embodiment, the fuzzy controller comprises a prescaling block, a rule block, a post-scaling block and a perturbation block. The pre-scaling block is arranged to receive the number of violating bytes and to normalise said number to lie within the range 0 to 1. The rule block is arranged to receive the normalised number and arranged to apply each of a plurality of fuzzy rules to the normalised number to determine a respective output value for each rule and to use the rule that gives the highest output value. The post-scaling block is arranged to convert the output value to an output number of bytes. The perturbation block is arranged to apply a perturbation value to the output number of bytes to form the estimated committed burst size correction. The perturbation value is in an opposite direction to the output number of bytes.

In an embodiment, the controller is arranged to output the previously used estimated committed burst size with the perturbation value applied to it.

In an embodiment, the estimator loop further comprises a violating byte mean estimator arranged to determine a mean value, Ŷ, of the number of violating bytes received within an integration period, as

$$\hat{Y} = \frac{1}{N} {Σ}_{i} {Y}_{i} .$$

Dividing the integration period into N sub-periods may reduce noise effects in Ŷ.

In an embodiment, the controller is arranged to, if the mean value, Ŷ, of the number of violating bytes is above zero, determine an estimated committed burst size correction in dependence on the mean value. The controller is arranged to apply the correction to the estimated committed burst size. The controller is arranged to, if the mean value is zero, output the previously used estimated committed burst size with the perturbation value applied to it. In an embodiment, the fuzzy controller pre-scaling block is arranged to receive the mean value of the number of violating bytes and to normalise the mean value to lie within the range 0 to 1. The rule block is arranged to receive the normalised mean value and arranged to apply each of a plurality of fuzzy rules to the normalised mean value to determine a respective output value for each rule and to use the rule that gives the highest output value. The post-scaling block is arranged to convert the output value to an output number of bytes. The perturbation block arranged to apply a perturbation value to the output number of bytes to form the estimated committed burst size correction. The perturbation value is in an opposite direction to the output number of bytes.

The meter operates such that there are no violating bytes if the ECBS is greater than or equal to the committed burst size, CBS. Therefore if the last correction value that is applied is too big, it would be possible for the estimation to fail, since ECBS could be greater then the real CBS without it being possible to detect this. The perturbation block introduces a variation on the controller output in the opposite direction of the last correction, decreasing the output of the controller by a quantity proportional to the output of the post-scaling block. In this way, if ECBS≧CBS the last non-zero computed perturbation value is applied time by time to the output allowing convergence to the real CBS. The presence of the perturbation block introduces a small controllable and negligible oscillation on the ECBS, when in steady state.

In an embodiment, each fuzzy rule has the form out_{Rj}=μ_{Rj}(x)·Cⱼ where μ_{Rj} is a membership function of the x value to the fuzzy set related to rule Rⱼ and Cⱼ is a centroid of an output crisp set of the rule.

In an embodiment, the fuzzy rules membership functions and centroids are:

| | |
|---|---|
| Rule 0: (0, 0.005, 0.005, 0.015) | C0: 0.0025 |
| Rule 1: (0.005, 0.015, 0.02, 0.1) | C1: 0.0075 |
| Rule 2: (0.02, 0.05, 0.1, 0.25) | C2: 0.025 |
| Rule 3: (0.1, 0.25, 0.35, 0.5) | C3: 0.25 |
| Rule 4: (0.35, 0.5, 0.75, 1.0) | C4: 0.5 |
| Rule 5: (0.75, 1.0, 1.0, 1.0) | C5: 1.0 |

In an embodiment, the peak information rate estimator is arranged to solve the operating research problem:

$$find max x \text{:}$$

$$x = \frac{1}{1 - \frac{ECBS}{\hat{B}} \cdot n}$$

$$n < {N}_{MAX}$$

and to determine the estimated peak information rate as EPIR=x·ECIR

Determining EPIR in this way may overcome the problem of defining an appropriate integration window for determining

$$\hat{PIR} = \frac{arrived bytes}{time window}$$

for different traffic flows. It may also avoid over-sampling and noise effects or sub-sampling. The PIR estimator ensures that as soon as ECIR and ECBS are meaningful, the PIR estimation becomes significant.

In an embodiment, the x exploration is implemented for x in the range 2 to 10. In an embodiment, the operating research problem is solved using a linear programming method.

In an embodiment, the effective bandwidth estimator is arranged to apply the equation:

$$Eff . BW = \frac{EPIR}{1 + \frac{D}{ECBS} \cdot ( EPIR - ECIR )}$$

This may provide a simple, practical way of determining the effective bandwidth.

In an embodiment, the packet network traffic flow effective bandwidth estimation apparatus comprises a main logic controller arranged to generate and transmit a sampling command signal and an estimate command signal. The sampling command signal is arranged to cause the committed information rate estimator to obtain the number of conformant bytes, Gᵢ, and the number of violating bytes, Yᵢ, received by the meter within each sub-period and is arranged to cause the violating byte mean estimator to obtain the number of violating bytes, Yᵢ. The estimate command signal is arranged to cause the violating byte mean estimator to determine the mean value, Ŷ, and is arranged to cause the committed information rate estimator to determine the estimated committed information rate, ECIR, using one of

$$ECIR = \hat{B} \text{/} {T}_{i} and ECIR = \frac{1}{T} {Σ}_{i} {B}_{i} , where {B}_{i} = {Y}_{i} + {G}_{i} .$$

In an embodiment, the communications network switching node is an optical network switching node and the optic network is one of an optical packet switching network and an optical burst switching network.

A third aspect of the invention provides a method of estimating an effective bandwidth of a traffic flow in a packet network. The method comprises step a. of receiving a plurality of traffic packets of a traffic flow comprising a plurality of bytes. The method comprises step b. of determining a number of conformant bytes, being bytes of those packets which conform to an estimated committed information rate, ECIR, and an estimated committed burst size, ECBS. Step b. further comprises determining a number of violating bytes, being bytes of those packets which violate at least one of the estimated committed information rate and the estimated committed burst size. The method comprises step c. of determining a subsequent estimated committed information rate, being a number of bytes per second, from the number of conformant bytes and the number of violating bytes. The method comprises step d. of determining an estimated committed burst size correction in dependence on the number of violating bytes and applying the correction to the estimated committed burst size. The previously used estimated committed burst size is output. The method comprises step e. of repeating steps a. to d. The method comprises step f of determining an estimated peak information rate, EPIR, in dependence on the last output estimated committed burst size and the estimated committed information rate. The method comprises step g. of determining an effective bandwidth of the traffic flow from the estimated peak information rate, estimated committed burst size and estimated committed information rate.

The method may enable traffic flow characteristics to be determined in real-time, on a time-scale of fractions of a second. This is several hundred times faster than is achievable with the prior art and is consistent with the long term behaviour of self-similar traffic flows, which affect buffers in switches. The method may therefore be used to minimize time periods when congestion and losses occur in networks. The method may be used to self-size a multi-class packet network, and may enable an appropriate effective bandwidth to be instantaneously allocated to each traffic flow, thereby maximizing bandwidth exploitation.

The method may be used in optical burst switching and optical packet switching in optical networks. This may enable real-time bandwidth allocation to be achieved in optical networks, which may overcome the problems of waste of bandwidth currently experienced using “one way” reservation strategies and high jitter currently experienced using “two way” reservation strategies.

In an embodiment, the step e. comprises repeating steps a. to d. continuingly. In an embodiment, the traffic packets are received within an integration period T formed of a plurality, N, of sub-periods, Tᵢ. The number of conformant bytes, Gᵢ, and the number of violating bytes, Yᵢ, received within each sub-period are determined. The estimated committed information rate, ECIR, is determined using one of

$$ECIR = \hat{B} \text{/} {T}_{i} and ECIR = \frac{1}{T} {Σ}_{i} {B}_{i} , where {B}_{i} = {Y}_{i} + {G}_{i} .$$

Dividing the integration period into N sub-periods may reduce noise effects in the number of violating bytes.

In an embodiment, in step d. the estimated committed burst size correction is determined by sub-step i. of normalising said number to lie within the range 0 to 1, sub-step ii. of applying each of a plurality of fuzzy rules to the normalised number to determine a respective output value for each rule and using the rule that gives the highest output value, sub-step iii. of converting the output value to an output number of bytes, and sub-step iv. of applying a perturbation value to the output number of bytes to form the estimated committed burst size correction, the perturbation value being in an opposite direction to the output number of bytes.

In an embodiment, step d. comprises outputting the previously used estimated committed burst size with the perturbation value applied to it.

The method operates such that there are no violating bytes if the estimated committed burst size, ECBS, is greater than or equal to the committed burst size, CBS. Therefore if the last correction value that is applied is too big, it would be possible for the estimation to fail, since ECBS could be greater then the real CBS without it being possible to detect this. Step d. introduces a perturbation on the estimated committed burst size correction in the opposite direction of the last correction, decreasing the correction value by a quantity proportional to the output number of bytes. In this way, if ECBS≧CBS the last non-zero computed perturbation value is applied time by time to the output allowing convergence to the real CBS. Applying a perturbation value introduces a small controllable and negligible oscillation on the ECBS, when in steady state.

In an embodiment, the method further comprises determining a mean value, Ŷ, of the number of violating bytes received within an integration period, as

$$\hat{Y} = \frac{1}{N} {Σ}_{i} {Y}_{i} .$$

Dividing the integration period into N sub-periods may reduce noise effects in Ŷ.

In an embodiment, the step d. comprises, if the mean value, Ŷ, of the number of violating bytes is above zero, determining an estimated committed burst size correction in dependence on the mean value and applying the correction to the estimated committed burst size with the perturbation value applied to it. If the mean value is zero, step d. comprises outputting the previously used estimated committed burst size with the perturbation value applied to it. The method comprises step e. of repeating steps a. to d.

In an embodiment, each fuzzy rule has the form out_{Rj}=μ_{Rj}(x)·Cⱼ where μ_{Rj} is a membership function of the x value to the fuzzy set related to rule Rⱼ and Cⱼ is a centroid of an output crisp set of the rule.

In an embodiment, the fuzzy set rules membership functions and centroids are:

| | |
|---|---|
| Rule 0: (0, 0.005, 0.005, 0.015) | C0: 0.0025 |
| Rule 1: (0.005, 0.015, 0.02, 0.1) | C1: 0.0075 |
| Rule 2: (0.02, 0.05, 0.1, 0.25) | C2: 0.025 |
| Rule 3: (0.1, 0.25, 0.35, 0.5) | C3: 0.25 |
| Rule 4: (0.35, 0.5, 0.75, 1.0) | C4: 0.5 |
| Rule 5: (0.75, 1.0, 1.0, 1.0) | C5: 1.0 |

In an embodiment, the estimated peak information rate is determined by solving the operating research problem:

$$find max x \text{:}$$

$$x = \frac{1}{1 - \frac{ECBS}{\hat{B}} \cdot n}$$

$$n < {N}_{MAX}$$

and determining the estimated peak information rate as EPIR=x·ECIR

Determining EPIR in this way may overcome the problem of defining an appropriate integration window for determining

$$P \hat{I} R = \frac{arrived bytes}{time window}$$

for different traffic flows. It may also avoid over-sampling and noise effects or sub-sampling. It may also ensure that as soon as ECIR and ECBS are meaningful, the PIR estimation becomes significant.

In an embodiment, the x exploration is implemented for x in the range 2 to 10. In an embodiment, the operating research problem is solved using a linear programming method.

In an embodiment, the effective bandwidth estimator is determined using the equation:

$$Eff \cdot BW = \frac{EPIR}{1 + \frac{D}{ECBS} \cdot ( EPIR - ECIR )}$$

This may provide a simple, practical way of determining the effective bandwidth.

In an embodiment, the method further comprises generating and transmitting a sampling command signal and an estimate command signal. The sampling command signal is arranged to cause the committed information rate estimator to obtain the number of conformant bytes, Gᵢ, and the number of violating bytes, Yᵢ, received by the meter within each sub-period and is arranged to cause the violating byte mean estimator to obtain the number of violating bytes, Yᵢ. The estimate command signal is arranged to cause the violating byte mean estimator to determine the mean value, Ŷ, and is arranged to cause the committed information rate estimator to determine the estimated committed information rate, ECIR, using one of

$$ECIR = \hat{B} / {T}_{i}$$

$$and$$

$$ECIR = \frac{1}{T} {\sum }_{i}^{ } {B}_{i} , \\ where$$

$${B}_{i} = {Y}_{i} + {G}_{i} .$$

In an embodiment, the packet network is a communications network. In an embodiment, the packet network is one of an optical packet switching network and an optical burst switching network.

A fourth aspect of the invention provides a data carrier having computer readable instructions embodied therein. The computer readable instructions are for providing access to resources available on a processor and comprise instructions to cause the processor to perform the method of estimating an effective bandwidth of a traffic flow in a packet network as described above.

Embodiments of the invention will now be described, by way of example only, with reference to the accompanying drawings.

### BRIEF DESCRIPTION OF THE DRAWINGS

FIG. 1 is a schematic representation of a packet network traffic flow effective bandwidth estimation apparatus according to a first embodiment of the invention;

FIG. 2 is a schematic representation of a packet network traffic flow effective bandwidth estimation apparatus according to a second embodiment of the invention;

FIG. 3 is a schematic representation of the fuzzy controller of the apparatus of FIG. 2;

FIG. 4 is a schematic representation of the main logic controller of the apparatus of FIG. 2;

FIG. 5 shows the effective bandwidth output by the apparatus of FIG. 2 as a function of the number of operations of the loop (steps) during a simulation of its operation;

FIG. 6 shows the effective bandwidth error as a function of the number of operations of the loop (steps) for the effective bandwidths shown in FIG. 5;

FIG. 7 shows the steps of a method according to a third embodiment of the invention of estimating an effective bandwidth of a traffic flow in a packet network;

FIG. 8 shows the steps of a method according to a fourth embodiment of the invention of estimating an effective bandwidth of a traffic flow in a packet network;

FIG. 9 shows the step of determining an estimated committed burst rate correction of a method according to a fifth embodiment of the invention of estimating an effective bandwidth of a traffic flow in a packet network;

FIG. 10 shows the step of determining an estimated peak information rate of a method according to a sixth embodiment of the invention of estimating an effective bandwidth of a traffic flow in a packet network; and

FIG. 11 is a schematic representation of a communications network switching node according to a seventh embodiment of the invention.

### DETAILED DESCRIPTION

A first embodiment of the invention provides packet network traffic flow effective bandwidth estimation apparatus 10 as shown in FIG. 1.

The estimation apparatus 10 comprises a committed burst size estimator loop 12, a peak information rate, PIR, estimator 22 and an effective bandwidth, Eff.BW, estimator 24. The estimator loop 12 comprises a meter 14, a committed information rate, CIR, estimator 18 and a controller 20. The meter 14 is arranged to receive a plurality of traffic packets of a traffic flow 16 comprising a plurality of bytes. The meter is arranged to determine a number of conformant bytes, G, and a number of violating bytes, Y.

Conformant bytes are bytes of packets which conform to an estimated committed information rate, ECIR, and an estimated committed burst size, ECBS. Violating bytes are bytes of packets which violate at least one of the ECIR and the ECBS.

The CIR estimator 18 is arranged to determine a subsequent ECIR from the number of conformant bytes G and the number of violating bytes Y. The subsequent ECIR is a number of bytes per second. The controller 20 is arranged to determine an ECBS correction dependent on the number of violating bytes Y. The controller 20 is arranged to apply the correction to the ECBS, to form a subsequent ECBS. The controller is arranged to output the previously used ECBS.

The peak information rate, PIR, estimator 22 is arranged to receive the ECBS output from the controller 20 and the ECIR from the CIR estimator 18. The PIR estimator is arranged to determine an estimated peak information rate, EPIR, dependent on the ECBS and the ECIR.

The effective bandwidth estimator 24 is arranged to determine an effective bandwidth of the traffic flow from the EPIR, ECBS and ECIR.

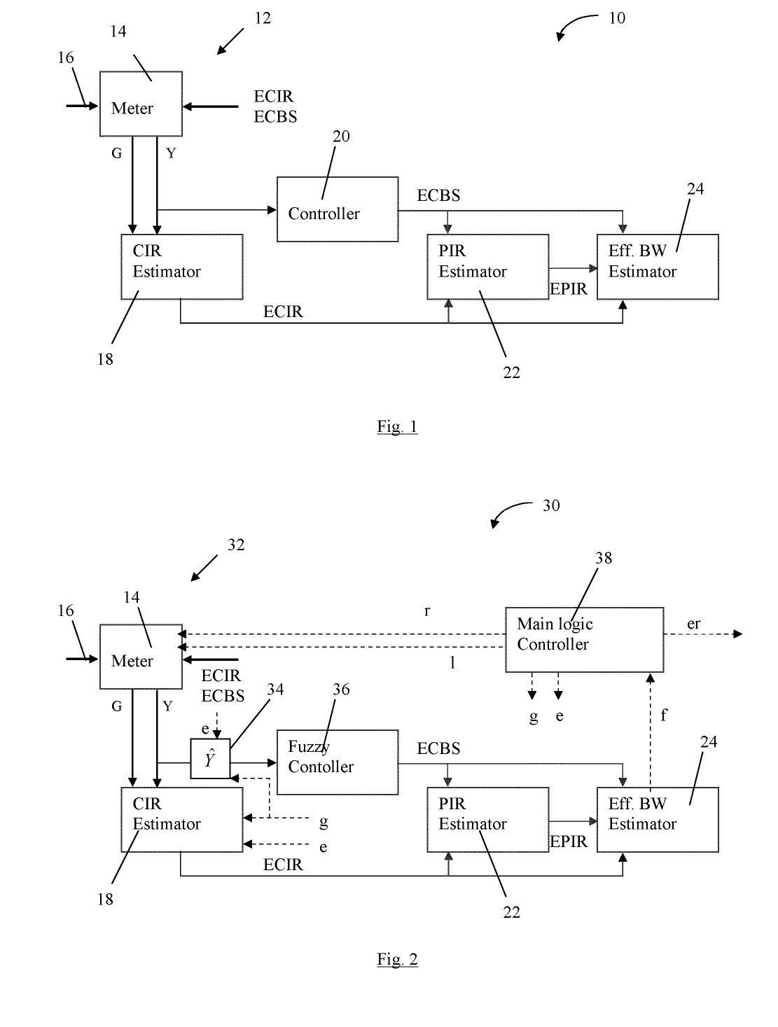

Packet network traffic flow effective bandwidth estimation apparatus 30 according to a second embodiment of the invention as shown in FIG. 2. The estimation apparatus of this embodiment is similar to the estimation apparatus 10 of FIG. 1, with the following modifications. The same reference numbers are retained for corresponding features.

In this embodiment the estimator loop 32 further comprises a violating byte mean estimator 34 which is arranged to determine a mean value, Ŷ, of the number of violating bytes received within an integration period. The violating byte mean estimator 34 is arranged to determine the mean value as

$$\hat{Y} = \frac{1}{N} {\sum }_{i}^{ } {Y}_{i} .$$

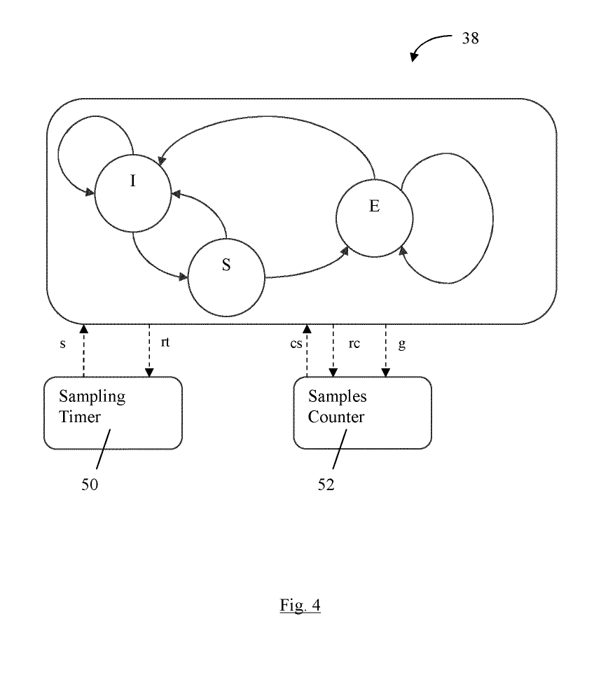

The effective bandwidth estimation apparatus 30 of this embodiment further comprises a main logic controller 38. The main logic controller coordinates operation of the other elements of the effective bandwidth estimation apparatus 30 and can be considered as a group of state machines operating according to the scheme shown in FIG. 4.

The main logic controller has the following states:

I: Idle

S: Sampling

E: Estimation

ns: sampling time not elapsed

s: sampling time elapsed

ss: still samples to count

cs: completed samples count

rtme: load meter, restart meter and timer, provide Eff.BW

rtm: load meter, restart meter and timer

rc: restart counter

The meter 14 in this embodiment is a leaky bucket, built using a standard traffic regulator such as an RFC2698 two rate three colour marker. Where an RFC2698 traffic regulator is used only the leaky bucket related to CIR check is operated. The meter 14 is set time by time by the main logic controller with the ECIR and ECBS of the traffic flow 16. The meter 14 evaluates the violation of the ECIR with a tolerance given by the ECBS. The PIR bucket of the RFC2698 traffic regulator is set statically, in order to not generate violations at any time, so making it transparent. This is achieved by setting the PIR equal to the input line rate and the PBS to 65536 bytes plus overhead (so that it will host the largest possible packet). The traffic regulator outputs the number of Red (R), Yellow (Y) and Green (G) packets and bytes. Red bytes are related to packets which cause PIR violation, Yellow to packets which cause CIR violation and Green are bytes of packets conformant to the ECIR and ECBS. Using only the leaky bucket for the CIR check as the meter 14, the Yellow and Green output only are used. The sum B=Y+G of Yellow and Green bytes provides the total number B of bytes within an observation window, which is defined as the time occurring between an activation and a deactivation of the leaky bucket function by the main logic controller 38.

The CIR estimator 18 in this embodiment determines the subsequent ECIR as the mean number of bytes per second over an integration period, T. To reduce noise effects the integration time period T is divided into N time sub-periods Tᵢ. The number of conformant bytes, and the number of violating bytes, received within each sub-period are determined. For each sub-period a corresponding Bᵢ=Yᵢ+Gᵢ value is computed. After the N sub-periods, i.e. at the end of the integration time period T, the mean values \hat{B} and Ŷ are determined from the sampled Bᵢ and Yᵢ values respectively. The estimated committed information rate, ECIR, is determined using one of

$$ECIR = \hat{B} / {T}_{i}$$

$$and$$

$$ECIR = \frac{1}{T} {\sum }_{i}^{ } {B}_{i}$$

The controller of this embodiment is a fuzzy controller 36, constructed using a centre of gravity, COG, fuzzy system. The fuzzy controller 36 controls operation of the meter 14 by means of the ECBS variable. In principle, a steady state is reached when the number of violating bytes, Y, is zero. That is when the ECBS is equal to the CBS of the traffic flow 16. The fuzzy controller is a non-linear controller, which makes faster convergence possible than with a linear controller.

After every integration period, T, new values of Ŷ and \hat{B} are available. The fuzzy controller then determines an estimated committed burst size correction to be applied to the ECBS in order to reduce the number of violating bytes. After convergence (Y=0), the PIR estimation can be executed, or, said in another way, the PIR estimation becomes meaningful.

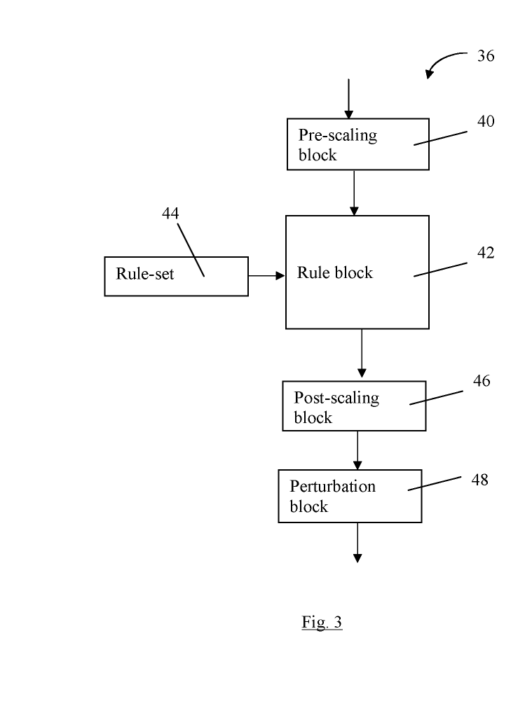

The architecture of the fuzzy controller 36 is shown in FIG. 3. The fuzzy controller comprises a pre-scaling block 40, a rule block 42, a post-scaling block 46 and a perturbation block 48.

The pre-scaling block 40 is arranged to receive the mean number of violating bytes, Ŷ, and to normalise the mean to lie within the range 0 to 1. The rule block 42 is arranged to receive the normalised Ŷ value and to apply each of a plurality of fuzzy set rules 44 to the normalised Ŷ value to determine a respective output value for each rule and to use the rule that gives the highest output value.

Each fuzzy rule has the form out_{Rj}=μ_{Rj}(x)·Cⱼ where μ_{Rj} is a membership function of the normalised Ŷ value, x, to the fuzzy set related to rule Rⱼ and Cⱼ is a centroid of an output crisp set of the rule.

In this embodiment, the fuzzy set rules membership functions and centroids are:

| | |
|---|---|
| Rule 0: (0, 0.005, 0.005, 0.015) | C0: 0.0025 |
| Rule 1: (0.005, 0.015, 0.02, 0.1) | C1: 0.0075 |
| Rule 2: (0.02, 0.05, 0.1, 0.25) | C2: 0.025 |
| Rule 3: (0.1, 0.25, 0.35, 0.5) | C3: 0.25 |
| Rule 4: (0.35, 0.5, 0.75, 1.0) | C4: 0.5 |
| Rule 5: (0.75, 1.0, 1.0, 1.0) | C5: 1.0 |

The post-scaling block 46 is arranged to convert the output value of the selected fuzzy rule into an output number of bytes.

The perturbation block 48 is arranged to apply a perturbation value to the output number of bytes to form the ECBS correction. The perturbation value is in an opposite direction to the most recently determined correction. A meter 14 implemented with a leaky bucket states that Ŷ=0 (no violations), if ECBS≧CBS. Therefore if the last ECBS correction applied is too big, the estimation can fail, because the ECBS could be greater then the real CBS without any possibility of detecting this. The perturbation block introduces a variation on the ECBS correction values in the opposite direction of the last correction, thereby decreasing the ECBS correction output by the fuzzy controller by a quantity proportional to the output of the post-scaling block 36. For example, by a factor of ⅓. In this way, if ECBS≧CBS the last non-zero perturbation value is applied time after time to the ECBS allowing convergence to the real CBS. The presence of the perturbation block 48 introduces a small controllable and negligible oscillation on the ECBS, when in a steady state. When Ŷ converges to zero the ECBS output by the fuzzy controller is meaningful therefore EPIR and the Effective Bandwidth and be correctly determined.

The estimator loop 32 is arranged to operate continuingly.

The controller 36 is arranged to determine an ECBS correction dependent on the number of violating bytes Y. The controller 36 is arranged to apply the correction to the ECBS, to form a subsequent ECBS. The controller is arranged to output the previously used ECBS with the perturbation value applied to it. The PIR estimator 22 of this embodiment is arranged to solve the operating research problem:

$$find max x \text{:}$$

$$x = \frac{1}{1 - \frac{ECBS}{\hat{B}} \cdot n}$$

$$n < {N}_{MAX}$$

and to determine the estimated peak information rate as EPIR=x·ECIR

This is based on the assumptions that PIR=x·CIR, where x is an integer, that all the incoming traffic is leaky-bucket regulated, and the traffic is on-off, periodic and extremal, that is to say the source of the traffic transmits at peak rate when it is on. The amount of traffic generated in one period, that is the number of bytes transmitted in a burst, is given by:

$$Q = CBS \frac{PIR}{PIR - CIR} = CBS \frac{x}{x - 1} \qquad ( 1 )$$

which is an approximation that holds on average.

The \hat{B} estimated value can be assumed to be given by \hat{B}=n·Q+α. That is, \hat{B} is equal to an integer number of bursts, n, plus some bytes that are part of a burst that is still being received. In this case the inequality \hat{B}≧n·Q holds.

Using (1) we obtain

$$\hat{B} \geq n \cdot Q = n \cdot ECBS \frac{x}{x - 1}$$

that provides the following inequality in two variables, n and x, with xεℑ⁺ and nεℑ⁺.

$$x \geq \frac{1}{1 - \frac{ECBS}{\hat{B}} \cdot n} \qquad ( 2 )$$

Rearranging (2) the following equation can also be obtained

$$\frac{\hat{B}}{ECBS} \geq n \frac{x}{x - 1} > n$$

where the number of bursts, n, is an integer, a constraint on its maximum value, N_{MAX}, can be applied and n can be assumed to be

$${N}_{MAX} = ⌊ \frac{\hat{B}}{ECBS} ⌋ > n \qquad ( 3 )$$

If NMAX≦1, PIR=CIR, otherwise the following operating research problem is solved:

$$find max x \text{:}$$

$$x = \frac{1}{1 - \frac{ECBS}{\hat{B}} \cdot n}$$

$$n < {N}_{MAX}$$

using any standard operating research methodology. In this embodiment an exhaustive method of finding x was used, computing all possible solutions in a selected range. Since

$$\frac{x}{x - 1}$$

has an asymptotic behaviour in the interesting range [2:∞], it is enough to limit the x exploration to the range [2,10], so that no more than 10 search cycles are required to find x. Alternatively the gradient method may be used to reduce the number of search cycles or the Simplex linear programming method may be used.

The EPIR is then determined using the highest value of x which did not cause a violation of N_{MAX}:

EPIR=x·ECIR (4)

In this embodiment, the effective bandwidth estimator arranged to determine an effective bandwidth, Eff.BW, of the traffic flow using:

$$Eff \cdot BW = \frac{EPIR}{1 + \frac{D}{ECBS} \cdot ( EPIR - ECIR )} \qquad ( 5 )$$

where D is a network node parameter defining the maximum jitter the node is allowed to introduce to the connection due to buffering in case of congestion. A typical value for Real-Time traffic is 250 μs. Equation (5) is obtained from J. D. Angelopoulos et at, “An Optical Network Architecture With Distributed Switching Inside Node Clusters Features Improved Loss, Efficiency, and Cost. Journal of Lightwave Technology, Volume 25, No. 5, May 2007.

The main logic controller 38 coordinates the activities of the effective bandwidth estimation apparatus 30. The main logic controller has three states: Idle; Sampling; and Estimation. In the “Idle” state the main logic controller 38 waits for the sampling timer 50 to complete counting down a sampling time. When the sampling time has elapsed, the sampling timer triggers the main logic controller 38 to change state into the “Sampling” state. The Y and G data are sampled from the meter 14, the corresponding B value is computed and Y, G and B are stored in an entry of corresponding sampling vectors within the main logic controller 28. As the Y and G data are sampled, a samples counter 52 is decremented. When it reaches zero it is reloaded with the required number of samples. When this event occurs, the main logic controller 38 enters the “Estimation” state. Otherwise it enters the “Idle” state and restarts the sampling timer and the meter in order to get new samples. When the main logic controller enters the “Estimation” state, the stored values of Y, G and B are used to determine ECIR, ECBS, EPIR in this order. These values are then used to determine the Effective Bandwidth. The main logic controller 38 then enters the “Idle” state, and loads the meter 14 with the new ECIR and ECBS values, restarting both the sampling timer 50 and the meter 14.

The main logic controller 38 is arranged to generate and transmit a sampling command signal, g, and an estimate command signal, e. The sampling command signal is arranged to cause the CIR estimator 18 to obtain the number of conformant bytes, Gᵢ, and the number of violating bytes, Yᵢ, received by the meter 14 within each sub-period. The sampling command signal is also arranged to cause the Ŷ estimator 34 to obtain the number of violating bytes, Yᵢ. The estimate command signal is arranged to cause the Ŷ estimator to determine the mean value, Ŷ, and is arranged to cause the CIR estimator to determine the estimated committed information rate, ECIR.

The main logic controller 38 sends command signals only to the Ŷ and CIR estimators and to the meter. The fuzzy controller, the PIR estimator and the Eff.BW estimator are input data driven, that is they start operating when they receive new inputs.

The Ŷ and CIR estimators sample new input data from the meter every time they receive the sampling command from the main logic controller 38. The Ŷ and CIR estimators compute the new estimation when they receive the estimate command. As soon as a new Ŷ is available the fuzzy controller starts operation. In a similar way, the PIR estimator starts operation when it receives a new ECBS and ECIR and, finally the Eff.BW estimator starts operation as soon as the new ECBS, ECIR and EPIR are available. Each input driven block needs to receive a new value for all its inputs before starting operation.

The main logic controller 38 is further arranged to generate and transmit a load signal, 1, to the meter 14 which is arranged to cause the meter to load a new couple of values ECIR and ECBS. The main logic controller 38 is further arranged to generate and transmit a restart signal, r, which is arranged to cause the meter to start a new cycle.

The effective bandwidth estimator is arranged to generate and transmit a finished signal, f, arranged to inform the main logic controller that all the estimations are ready and a new estimation cycle can start. A finished signal is sent by the Eff.BW estimator each time it has computed a new Eff.BW value.

The main logic controller 38 is further arranged to generate and transmit an Effective bandwidth ready signal, er, which is a strobe signal arranged to indicate that a new Eff.BW estimation is available.

To evaluate the performance of the effective bandwidth estimation apparatus 30 a simulator was built and simulations for traffic flows with a variety of characteristics values (PIR, CIR and CBS) were made in order to test the apparatus 30 in several test conditions.

One example of a traffic flow that was simulated is:

| PIR | CIR | CBS | Eff. BW |
|---|---|---|---|
| 15 MB/s | 2.4 MB/s | 21000 Bytes | 3.95 MB/s |

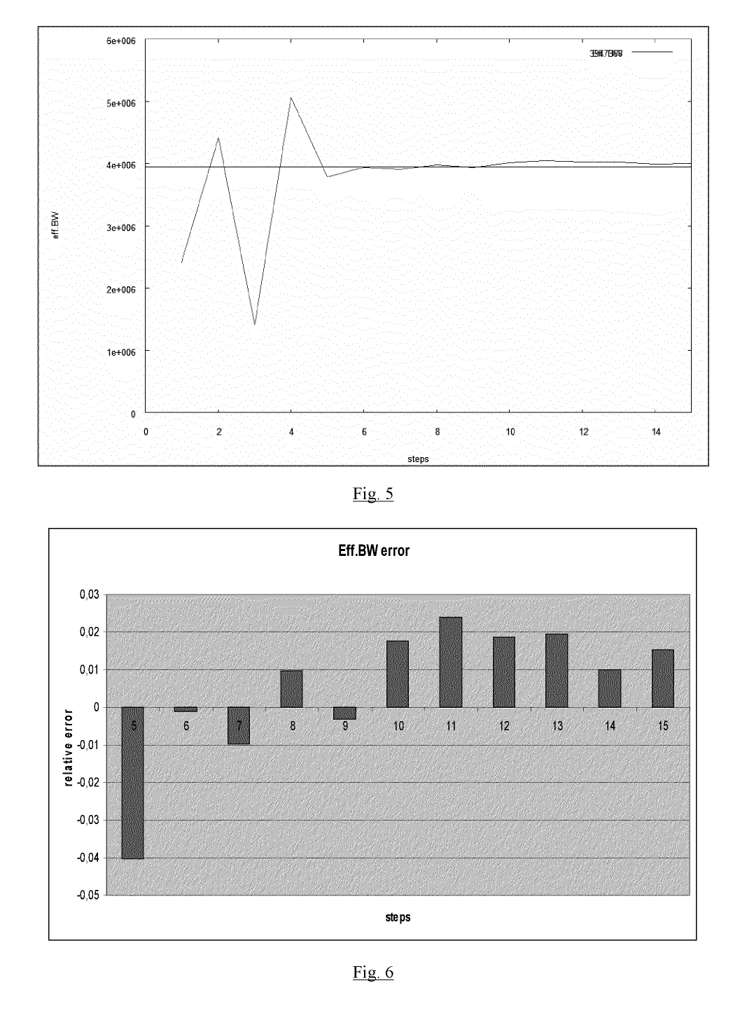

The effective bandwidth for this traffic flow is 3.95 MB/s and is shown as a horizontal line in FIG. 5. The effective bandwidth estimation apparatus 30 is able to estimate the Effective Bandwidth with a maximum relative error of about 2%, as shown in FIG. 6. An error of 5% can be considered good. The estimated value is stable enough starting from the 5^{th} cycle (step).

During the simulations the apparatus 30 was set with an integration sub-period of 0.2-0.3 s, which means that the effective bandwidth estimation was available in about 1 s. Shorter sub-periods can be used. The size of the sub-period depends on the number of samples that arrive during this time interval in order to have a significant set of measurements. The higher the traffic rate, the shorter the sub-period must be.

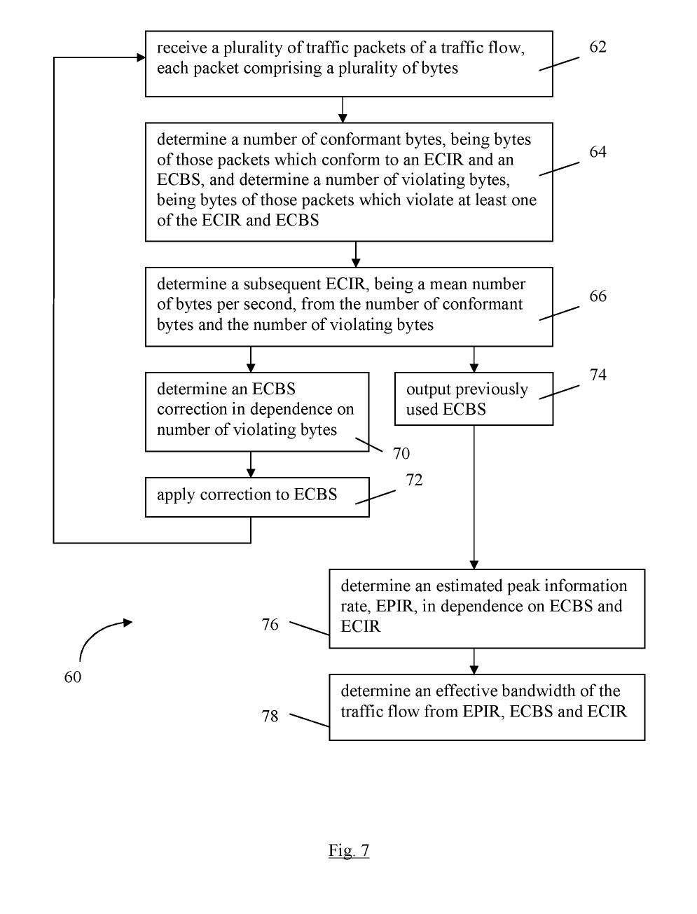

A third embodiment of the invention provides a method 60 of estimating an effective bandwidth of a traffic flow in a packet network. The steps of the method 60 are shown in FIG. 7.

The method comprises step a. of receiving a plurality of traffic packets of a traffic flow 62 comprising a plurality of bytes.

The method comprises step b. of determining a number of conformant bytes and a number of violating bytes 64. Conformant bytes are bytes of those packets which conform to an estimated committed information rate, ECIR, and an estimated committed burst size, ECBS. Violating bytes are bytes of those packets which violate at least one of the estimated committed information rate and the estimated committed burst size.

The method comprises step c. of determining a subsequent estimated committed information rate from the number of conformant bytes and the number of violating bytes 66. The subsequent estimated committed information rate is a number of bytes per second.

The method comprises step d. of determining an estimated committed burst size correction in dependence on said number 70. Step d. comprises applying the correction to the estimated committed burst size 72. Step d. comprises outputting the previously used estimated committed burst size 74.

The method comprises step e. of repeating steps a. to d.

The method comprises step f. of determining an estimated peak information rate, EPIR, in dependence on the last output estimated committed burst size and the last estimated committed information rate, ECIR 76.

The method comprises step g. of determining an effective bandwidth of the traffic flow from the estimated peak information rate, estimated committed burst size and estimated committed information rate 78.

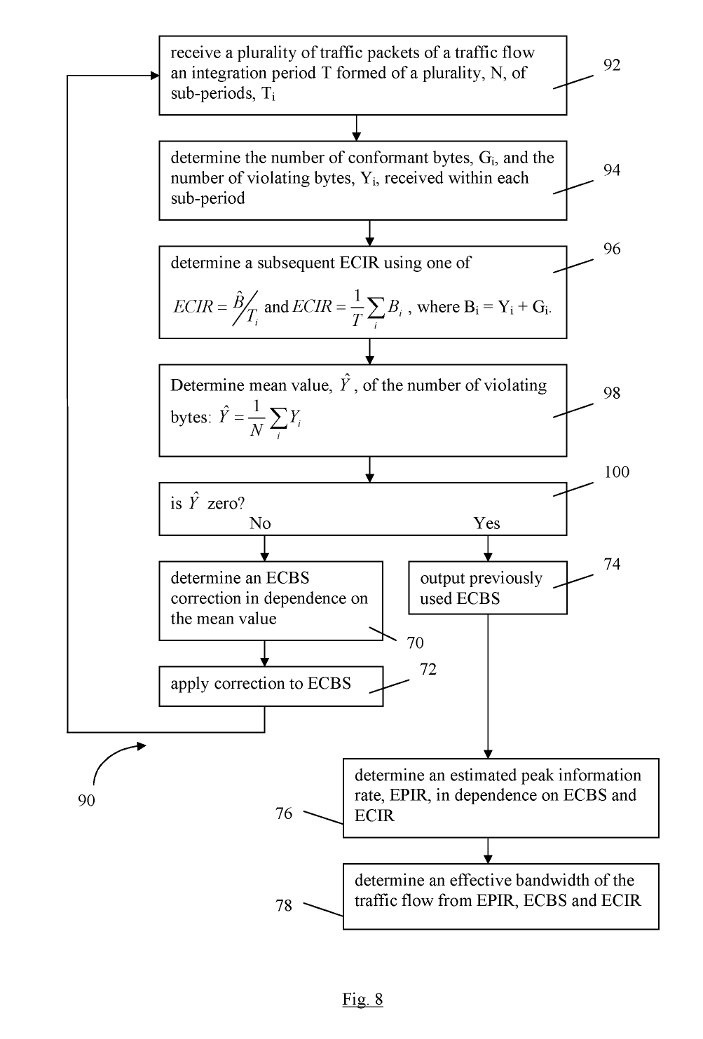

A fourth embodiment of the invention provides a method 90 of estimating an effective bandwidth of a traffic flow in a packet network. The steps of the method 60 are shown in FIG. 8. The method 90 of this embodiment is similar to the method 60 of FIG. 7, with the following modifications. The same reference numbers are retained for corresponding steps.

In this embodiment, the traffic packets are received within an integration period T formed of a plurality, N, of sub-periods, Tᵢ 92. The number of conformant bytes, Gᵢ, and the number of violating bytes, Yᵢ, received within each sub-period are determined 94. The ECIR is determined (96) using one of

$$ECIR = \hat{B} / {T}_{i}$$

$$and$$

$$ECIR = \frac{1}{T} {\sum }_{i}^{ } {B}_{i}$$

$$where$$

$${B}_{i} = {Y}_{i} + {G}_{i} .$$

Step b. further comprises determining a mean value, Ŷ, of the number of violating bytes received within an integration period 98. The mean value is determined as

$$\hat{Y} = \frac{1}{N} {Σ}_{i} {Y}_{i}$$

Step d. comprises, if the mean value Ŷ is above zero 100, determining an estimated committed burst size correction in dependence on the mean value. If the mean value is zero, step d. comprises outputting the previously used estimated committed burst size 74. Step e. comprises repeating steps a. to d. continuingly

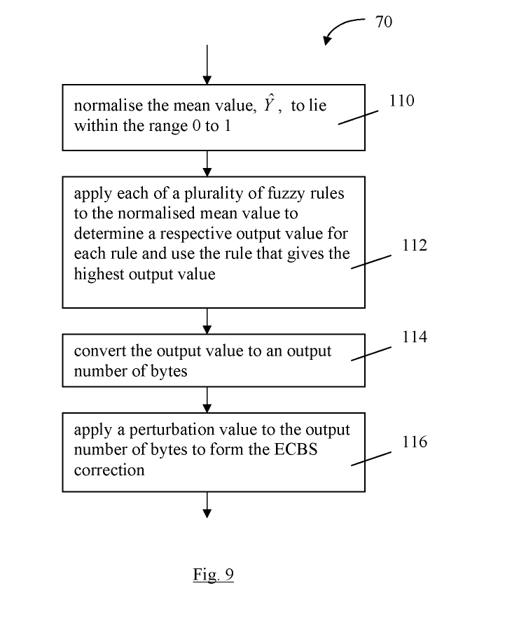

FIG. 9 shows the steps of determining an ECBS correction 70 of a method according to a fifth embodiment of the invention of estimating an effective bandwidth of a traffic flow in a packet network. The remainder of the steps of the method of this embodiment are similar to those shown in FIG. 7, with the following modifications.

In this embodiment the ECBS is determined by sub-steps i. to iv. Sub-step i. comprises 110 normalising the mean value Ŷ to lie within the range 0 to 1. Sub-step ii. comprises applying each of a plurality of fuzzy set rules to the normalised mean value to determine a respective output value for each rule 112. The rule that gives the highest output value is used. Sub-step iii. comprises converting the output value to an output number of bytes 114. Sub-step iv. comprises applying a perturbation value to the output number of bytes to form the ECBS correction 116. The perturbation value is in an opposite direction to the previously applied correction. The perturbation value is proportional to the output number of bytes and is arranged to decrease the estimated committed burst size correction.

Step d. comprises outputting the previously used estimated committed burst size with the perturbation value applied to it.

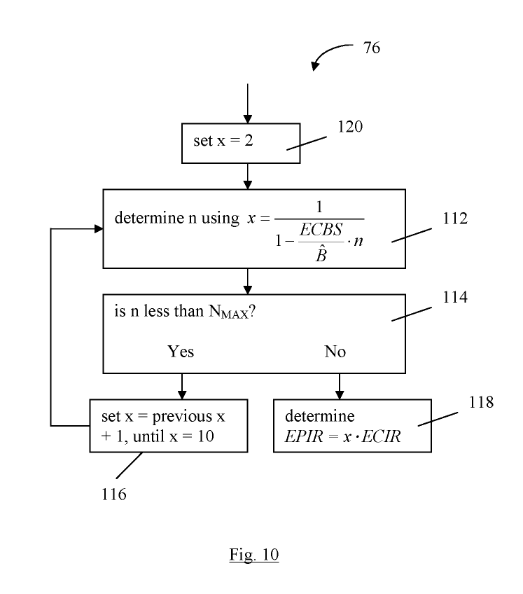

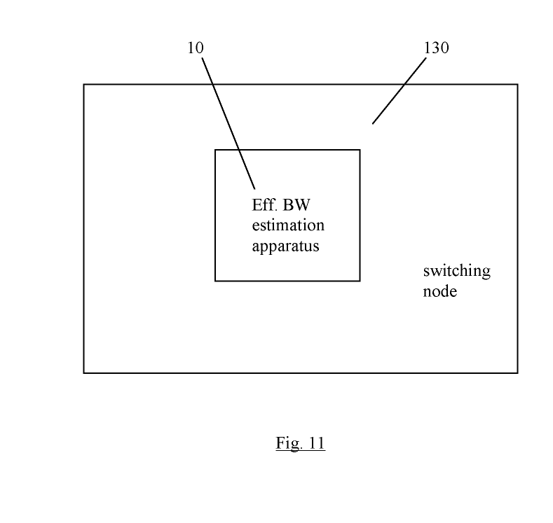

The step 76 of determining the EPIR of a method according to a sixth embodiment of the invention of estimating an effective bandwidth of a traffic flow in a packet network is shown in FIG. 10. The remainder of the steps of this method are as shown in FIG. 8.

The ECIR is determined by solving the operating research problem:

$$find max x \text{:}$$

$$x = \frac{1}{1 - \frac{ECBS}{\hat{B}} \cdot n}$$

$$n < {N}_{MAX}$$

and the estimated peak information rate is determined as EPIR=x·ECIR.

This is based on the assumptions that PIR=x·CIR, where x is an integer, that all the incoming traffic is leaky-bucket regulated, and the traffic is on-off, periodic and extremal, that is to say the source of the traffic transmits at peak rate when it is on. The amount of traffic generated in one period, that is the number of bytes transmitted in a burst, is given by:

$$Q = CBS \frac{PIR}{PIR - CIR} = CBS \frac{x}{x - 1} \qquad ( 1 )$$

which is an approximation that holds on average.

The \hat{B} estimated value can be assumed to be given by \hat{B}=n·Q+α. That is, \hat{B} is equal to an integer number of bursts, n, plus some bytes that are part of a burst that is still being received. In this case the inequality \hat{B}≧n·Q holds.

Using (1) we obtain

$$\hat{B} \geq n \cdot Q = n \cdot ECBS \frac{x}{x - 1}$$

that provides the following inequality in two variables, n and x, with xεℑ⁺ and nεℑ⁺.

$$x \geq \frac{1}{1 - \frac{ECBS}{\hat{B}} \cdot n} \qquad ( 2 )$$

Rearranging (2) the following equation can also be obtained

$$\frac{\hat{B}}{ECBS} \geq n \frac{x}{x - 1} > n$$

where the number of bursts, n, is an integer, a constraint on its maximum value, N_{MAX}, can be applied and n can be assumed to be

$${N}_{MAX} = ⌊ \frac{\hat{B}}{ECBS} ⌋ > n \qquad ( 3 )$$

If NMAX≦1, PIR=CIR, otherwise the following operating research problem is solved:

$$find max x \text{:}$$

$$x = \frac{1}{1 - \frac{ECBS}{\hat{B}} \cdot n}$$

$$n < {N}_{MAX}$$

using any standard operating research methodology. In this embodiment an exhaustive method of finding x was used, computing all possible solutions in a selected range. Alternatively the gradient method may be used to reduce the number of search cycles or the Simplex linear programming method may be used. Since

$$\frac{x}{x - 1}$$

has an asymptotic behaviour in the interesting range [2:∞], it is enough to limit the x exploration to the range [2,10] 120, 112, 114, 116, so that no more than 10 search cycles are required to find x.

EPIR is then determined 118 using the highest value of x which did not cause a violation of N_{MAX}:

EPIR=x·ECIR (4)

The effective bandwidth, Eff.BW, of the traffic flow is determined using:

$$Eff . BW = \frac{EPIR}{1 + \frac{D}{ECBS} \cdot ( EPIR - ECIR )} \qquad ( 5 )$$

where D is a network node parameter defining the maximum jitter the node is allowed to introduce to the connection due to buffering in case of congestion. A typical value for Real-Time traffic is 250 μs. Equation (5) is obtained from J. D. Angelopoulos et at, “An Optical Network Architecture With Distributed Switching Inside Node Clusters Features Improved Loss, Efficiency, and Cost. Journal of Lightwave Technology, Volume 25, No. 5, May 2007.

A communications network switching node 130 according to a seventh embodiment of the invention is shown in FIG. 11.

The node 130 comprises effective bandwidth estimation apparatus 10, as shown in

FIG. 1. The node 130 may alternatively comprise the effective bandwidth estimation apparatus 30 shown in FIGS. 2 to 4.

An eighth embodiment of the invention provides a data carrier having computer readable instructions embodied therein. The computer readable instructions are for providing access to resources available on a processor and comprise instructions to cause the processor to perform any of the methods of estimating an effective bandwidth of a traffic flow in a packet network as described in relation to FIGS. 7 to 10.

1. A packet network traffic flow effective bandwidth estimation apparatus comprising:
a committed burst size estimator loop comprising:
a meter arranged to receive a plurality of traffic packets of a traffic flow comprising a plurality of bytes and arranged to determine a number of conformant bytes, being bytes of those packets which conform to an estimated committed information rate (ECIR) and an estimated committed burst size (ECBS) and arranged to determine a number of violating bytes, being bytes of those packets which violate at least one of the estimated committed information rate and the estimated committed burst size;
a committed information rate estimator arranged to determine a subsequent estimated committed information rate, being a number of bytes per second, from the number of conformant bytes and the number of violating bytes; and
a controller arranged to determine an estimated committed burst size correction in dependence on the number of violating bytes and to apply the correction to the estimated committed burst size, and arranged to output the previously used estimated committed burst size;
a peak information rate estimator arranged to receive the estimated committed burst size output from the loop and the estimated committed information rate and arranged to determine an estimated peak information rate (EPIR) in dependence on the estimated committed burst size and the estimated committed information rate; and
an effective bandwidth estimator arranged to determine an effective bandwidth of the traffic flow from the estimated peak information rate, estimated committed burst size and estimated committed information rate.

2. The packet network traffic flow effective bandwidth estimation apparatus as claimed in claim 1, wherein the meter is arranged to receive traffic packets within an integration period T formed of a plurality, N, of sub-periods, Tᵢ, and is arranged to determine the number of conformant bytes, Gᵢ, and the number of violating bytes, Yᵢ, received within each sub-period, and the committed information rate estimator is arranged to determine the estimated committed information rate (ECIR) using one of
$$ECIR = \hat{B} \text{/} {T}_{i} and ECIR = \frac{1}{T} {Σ}_{i} {B}_{i} , where {B}_{i} = {Y}_{i} + {G}_{i} .$$

3. The packet network traffic flow effective bandwidth estimation apparatus as claimed in claim 1, wherein the controller is a fuzzy controller.

4. The packet network traffic flow effective bandwidth estimation apparatus as claimed in claim 3, wherein the fuzzy controller comprises:
a pre-scaling block arranged to receive the number of violating bytes and to normalise said number to lie within a range 0 to 1;
a rule block arranged to receive the normalised number and arranged to apply each of a plurality of fuzzy rules to the normalised number to determine a respective output value for each rule and to use the rule that gives a highest output value;
a post-scaling block arranged to convert the output value to an output number of bytes; and
a perturbation block arranged to apply a perturbation value to the output number of bytes to form the estimated committed burst size correction, the perturbation value being in an opposite direction to the output number of bytes.

5. The packet network traffic flow effective bandwidth estimation apparatus as claimed in claim 4, wherein the perturbation value is proportional to the output number of bytes and is arranged to decrease the estimated committed burst size correction and the controller is arranged to output the previously used estimated committed burst size with the perturbation value applied to it.

6. The packet network traffic flow effective bandwidth estimation apparatus as claimed in claim 1, wherein the peak information rate estimator is arranged to solve an operating research problem given as:
$$find max x \text{:}$$
$$x = \frac{1}{1 - \frac{ECBS}{\hat{B}} \cdot n}$$
$$n < {N}_{MAX}$$
and to determine the estimated peak information rate as EPIR=x·ECIR

7. The packet network traffic flow effective bandwidth estimation apparatus as claimed in claim 6, wherein the x exploration is implemented for x in a range 2 to 10.

8. A method of estimating an effective bandwidth of a traffic flow in a packet network, the method comprising:
a. receiving a plurality of traffic packets of a traffic flow comprising a plurality of bytes;
b. determining a number of conformant bytes, being bytes of those packets which conform to an estimated committed information rate (ECIR) and an estimated committed burst size (ECBS) and determining a number of violating bytes, being bytes of those packets which violate at least one of the estimated committed information rate and the estimated committed burst size;
c. determining a subsequent estimated committed information rate, being a number of bytes per second, from the number of conformant bytes and the number of violating bytes;
d. determining an estimated committed burst size correction in dependence on the number of violating bytes and applying the correction to the estimated committed burst size, and outputting the previously used estimated committed burst size;
e. repeating steps a. to d.;
f. determining an estimated peak information rate (EPIR) in dependence on the last output estimated committed burst size and the estimated committed information rate; and
g. determining an effective bandwidth of the traffic flow from the estimated peak information rate, estimated committed burst size and estimated committed information rate.

9. The method as claimed in claim 8, wherein the traffic packets are received within an integration period T formed of a plurality, N, of sub-periods, Tᵢ, and the number of conformant bytes, Gᵢ, and the number of violating bytes, Yᵢ, received within each sub-period are determined, and the estimated committed information rate (ECIR) is determined using one of
$$ECIR = \hat{B} \text{/} {T}_{i} and ECIR = \frac{1}{T} {Σ}_{i} {B}_{i} , where {B}_{i} = {Y}_{i} + {G}_{i} .$$

10. The method as claimed in claim 8, wherein in step d. the estimated committed burst size correction is determined by:
i. normalising said number to lie within the range 0 to 1;
ii. applying each of a plurality of fuzzy set rules to the normalised number to determine a respective output value for each rule and using the rule that gives a highest output value;
iii. converting the output value to an output number of bytes; and
iv. applying a perturbation value to the output number of bytes to form the estimated committed burst size correction, the perturbation value being in an opposite direction to the previously applied correction.

11. The method as claimed in claim 10, wherein the perturbation value is proportional to the output number of bytes and is arranged to decrease the estimated committed burst size correction and step d. comprises outputting the previously used estimated committed burst size with the perturbation value applied to it.

12. The method as claimed in claim 8, wherein the estimated peak information rate is determined by solving an operating research problem given as:
$$find max x \text{:}$$
$$x = \frac{1}{1 - \frac{ECBS}{\hat{B}} \cdot n}$$
$$n < {N}_{MAX}$$
and determining the estimated peak information rate as EPIR=x·ECIR

13. The method as claimed in claim 12, wherein the x exploration is implemented for x in a range 2 to 10.

14. A communications network switching node comprising the packet network traffic flow effective bandwidth estimation apparatus as claimed in claim 1.

15. A non-transitory data carrier having computer readable instructions embodied therein, the computer readable instructions being for providing access to resources available on a processor and the computer readable instructions comprising instructions to cause the processor to perform a method of estimating an effective bandwidth of a traffic flow in a packet network, the method comprising:
a. receiving a plurality of traffic packets of a traffic flow comprising a plurality of bytes;
b. determining a number of conformant bytes, being bytes of those packets which conform to an estimated committed information rate (ECIR) and an estimated committed burst size (ECBS) and determining a number of violating bytes, being bytes of those packets which violate at least one of the estimated committed information rate and the estimated committed burst size;
c. determining a subsequent estimated committed information rate, being a number of bytes per second, from the number of conformant bytes and the number of violating bytes;
d. determining an estimated committed burst size correction in dependence on the number of violating bytes and applying the correction to the estimated committed burst size, and outputting the previously used estimated committed burst size;
e. repeating steps a. to d.;
f. determining an estimated peak information rate (EPIR) in dependence on the last output estimated committed burst size and the estimated committed information rate; and
g. determining an effective bandwidth of the traffic flow from the estimated peak information rate, estimated committed burst size and estimated committed information rate.
